(19) United States
(12) Patent Application Publication
(10) Pub. No.: US 2006/0087803 A1
(43) Pub. Date: Apr. 27, 2006

(54) Display device and mobile phone having the same

(75) Inventors: Ki-taek Kim, Yongin-si (KR); Dong-ok Kwak, Suwon-si (KR); Young-ki Kim, Yongin-si (KR); Seong-woon Booh, Yongin-si (KR); Jin-woo Cho, Seongnam-si (KR); Dong-woo Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/248,194

(22) Filed: Oct. 13, 2005

(30) Foreign Application Priority Data
Oct. 27, 2004 (KR) 2004-86083

(51) Int. Cl. G02F 1/1333; G06F 1/16

(52) U.S. Cl. 361/681; 349/58

(57) ABSTRACT

A display device of a mobile phone has a liquid crystal display (LCD) module; a first housing receiving and supporting the LCD module, and having guide ribs in a square frame configuration; a driving circuit board assembled to the first housing to be mounted on the guide ribs; and a second housing engaged with the first housing to enclose the driving circuit board and the LCD module. Exterior impact imposed on the driving circuit board is dispersed via the guide ribs throughout the first housing since the driving circuit board is mounted and supported on the guide ribs of the first housing. Accordingly, the impact transferred to the LCD module decreases.

### CROSS-REFERENCE TO RELATED APPLICATIONS

This application claims priority from Korean Patent Application No. 2004-86083 filed on Oct. 27, 2004, in the Korean Intellectual Property Office, the disclosure of which is incorporated herein by reference in its entirety.

### BACKGROUND OF THE INVENTION

1. Field of the Invention

The present invention relates to a mobile phone. More particularly, the present invention relates to a display device with an improved resistance against an impact and a mobile phone having the same.

2. Description of the Related Art

As is well-known, a mobile phone comprises a display device using an element such as a LCD (Liquid Crystal Display) which shows a dialed telephone number or a present status of a set function. There are various types of display devices, for example, the device may be integrally, slidably or pivotably formed with a mobile phone body. A so-called “folder type mobile phone”, in which the display device is pivotably engaged with respect to the mobile phone body, will be explained hereinafter.

The folder type mobile phone comprises a body having various electric parts therein, and a number of keypads for turning on/off a telecommunication, setting functions or dialing by a user's operation. The display device is hinged to the mobile phone body such that the keypads can be selectively exposed when a user opens or closes the mobile phone.

Referring to FIG. 1, a display device of a general mobile phone comprises a first housing 10, an LCD module 20, a driving circuit board 30, a second housing 40, a main LCD screen 50, and a sub-LCD screen 60.

The first housing 10 comprises guide ribs 11 for receiving and supporting the LCD module 20 therebetween, and an opening part 12 for exposing the LCD module 20. The guide ribs 11 may be a pair or two pairs.

The LCD module 20 is fitted in the first housing 10 by a first sealing member 21, and the driving circuit board 30 is assembled on an upper portion (in FIG. 1) of the LCD module 20. The LCD module 20 and the driving circuit board 30 are mounted in the guide rib 11, with four exterior surfaces of the LCD module 20 and the driving circuit board 30 supported by the inner surface of the guide rib 11.

The second housing 40 comprises a sub-opening part 42 for exposing the LCD module 20, and is engaged with the first housing 10.

The main LCD screen 50 is attached to the opening part 12 of the first housing 10, and the sub-LCD screen 60 is attached to the sub-opening part 42 of the second housing 40 by a second sealing member 41.

The aforementioned display device of a general mobile phone, however, has disadvantages in that, when there is an external impact on the device as shown as a thick arrow in FIG. 1, the impact is directly transferred via the sub-LCD screen 60 and the driving circuit board 30 to the LCD module 20 such that the LCD module 20 may be extremely bent or damaged as shown as a dotted line in FIG. 1.

Additionally, the display device of a general mobile phone has a problem in that the LCD module 20 and the driving circuit board 30 move when there is an external impact to increase the degree of impact.

### SUMMARY OF THE INVENTION

The present invention has been conceived to solve the above-mentioned problems occurring in the prior art, and an aspect of the present invention is to provide a display device of a mobile phone which disperses an exterior impact to reduce impact to an LCD module such that the LCD module can be prevented from being extremely bent and damaged by the exterior impact.

Another aspect of the present invention is to provide a display device of a mobile phone which can prevent the LCD module and a driving circuit board from moving by the exterior impact.

Yet another aspect of the present invention is to provide a mobile phone, especially a folder type mobile phone, having a display device with the aforementioned advantages.

In order to achieve the above aspects, there is provided a display device of a mobile phone comprising a liquid crystal display (LCD) module, a first housing which receives and supports the LCD module, and has at least a pair of guide ribs, a driving circuit board mounted and supported on the guide ribs to be assembled to the first housing, and a second housing enclosing the driving circuit board and the LCD module to be engaged with the first housing.

The display device may comprise guide ribs of square frame configurations.

The display device may comprise a pair of supporting ribs disposed between opposite sides of the second housing and the driving circuit board, for pressing and supporting the opposite sides of the driving circuit board during the engagement of the second housing with the first housing. The supporting ribs may be integrally formed with the second housing.

In order to achieve the above aspects, there is provided a display device for a mobile phone comprising a liquid crystal display (LCD) module, a first housing having at least a pair of guide ribs which receive and support the LCD module, and an opening part for exposing the LCD module, a driving circuit board mounted on a top of the guide ribs to be assembled to the first housing, a second housing enclosing the driving circuit board and the LCD module engaged with the first housing, and including a sub-opening part for exposing the LCD module to another direction, a main LCD screen attached to the opening part of the first housing, and a sub LCD screen attached to the sub-opening part of the second housing.

A first sealing member may be provided between edges of the LCD module and bottom surfaces of the first housing, and a second sealing member may be provided between edges of the sub-LCD screen and the second housing.

The LCD module engaged with the first housing by the first sealing member may be the same in height as the guide ribs.

In order to achieve the above aspects, there is provided a mobile phone comprising a mobile phone body having various electric field parts therein, and a number of keypads capable of turning on/off a telecommunication or setting functions and dialing by a user's operation; and a display device selectively exposing the keypads by a user's opening and closing, and showing a dialed telephone number or a present set function and status. The display device may include a liquid crystal display (LCD) module; a first housing having a guide rib configuring a square frame and receiving and supporting the LCD module, and having an opening part for exposing the LCD module; a driving circuit board mounted on a top of the guide rib to be assembled to the first housing; a second housing enclosing the driving circuit board and the LCD module to be engaged with the first housing and having a sub-opening part for exposing the LCD module in another direction; a main LCD screen attached to the opening part of the first housing; and a sub-LCD screen attached to the sub-opening part of the second housing.

The display device may be pivotably or slidably engaged with the mobile phone body.

### BRIEF DESCRIPTION OF THE DRAWINGS

The above and other aspects, features and advantages of the present invention will be more apparent from the following detailed description taken with reference to the accompanying drawings, in which:

FIG. 1 is a schematic sectional-view of a display device of a general mobile phone;

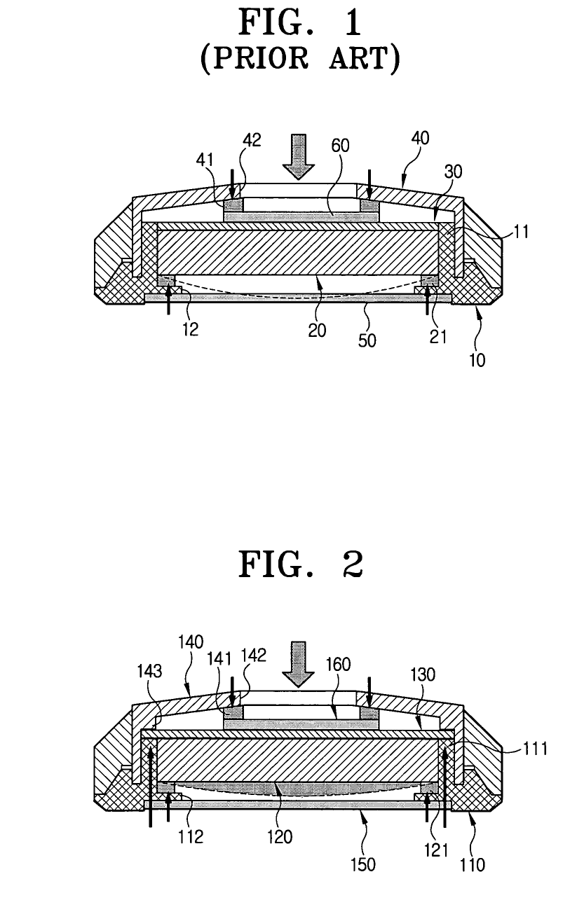

FIG. 2 is a sectional view of a display device of a mobile phone consistent with an exemplary embodiment of the present invention;

FIG. 3 is an exploded perspective-view of a display device of a mobile phone of FIG. 2 consistent with an exemplary embodiment of the present invention;

FIG. 4 and FIG. 4A are views of a mobile phone applying a display device consistent with exemplary embodiments of the present invention; and

FIG. 5 is a graph of a simulation result for explaining an effect of the present invention.

### DETAILED DESCRIPTION OF THE EXEMPLARY EMBODIMENTS

Certain embodiments of the present invention will be described in greater detail with reference to the accompanying drawings.

In the following description, the same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail since they would obscure the invention in unnecessary detail.

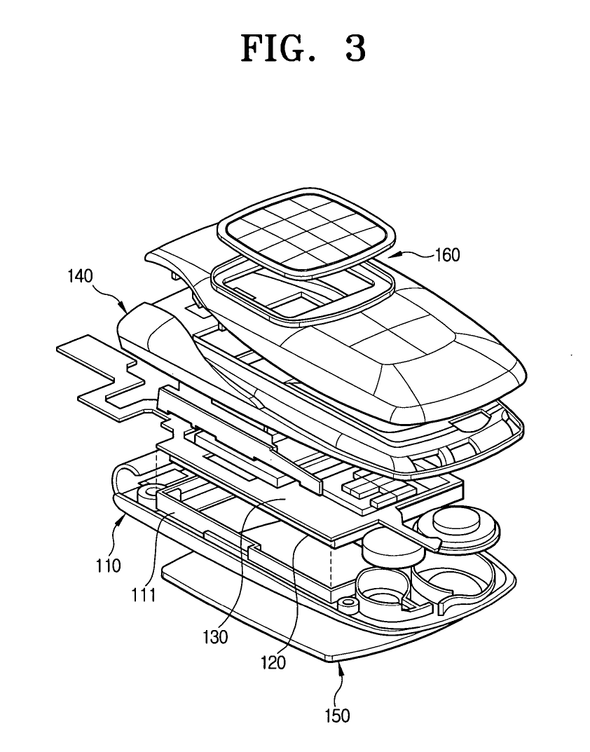

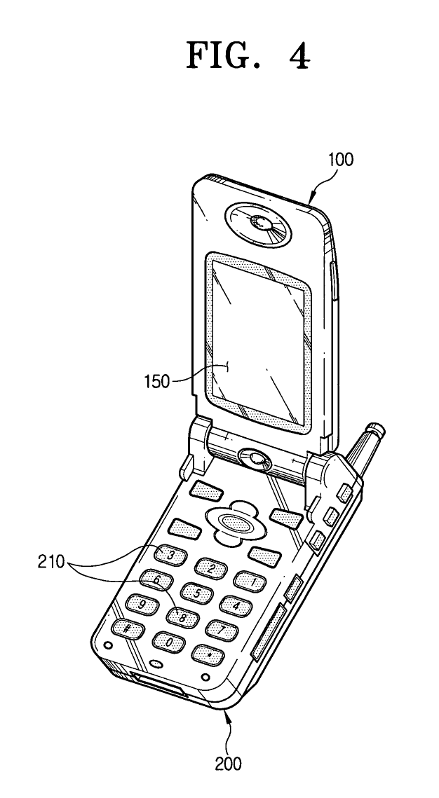

As shown in FIGS. 2 and 3, a display device of a mobile phone according to an embodiment of the present invention comprises a first housing 110, an LCD module 120, a driving circuit board 130, a second housing 140, a main LCD screen 150, and a sub-LCD screen 160.

The first housing 110 comprises guide ribs 111 of a certain height for receiving and supporting the LCD module 120 therebetween, and an opening part 112 for exposing the LCD module 120. The guide ribs 111 may be provided as a pair or as two pairs, and arranged as a square frame when provided as two pairs.

The LCD module 120 is engaged with the first housing 110 by a first sealing member 121. At this time, the LCD module 120 is mounted in the guide ribs 111 of the square frame. The LCD module 120 may be the same in height as the guide ribs 111. The height of the LCD module 120 is provided in view of the height of the first sealing member 121.

The driving circuit board 130 is assembled on the guide rib 111 according to an embodiment of the present invention. Particularly, four edges of a bottom surface of the driving circuit board 130 of square board configuration project beyond the top portion of the LCD module 120, with the edges supported by the top portion of the guide ribs 111, which take on the configuration of a square frame, of the first housing 110. An exterior impact onto the second housing 140 is dispersed via the driving circuit board 130 throughout the first housing 110 such that the degree of impact transferred to the LCD module 120 can be greatly reduced as compared to a conventional art.

The second housing 140 encloses the driving circuit board 130 and the LCD module 120 to be engaged with the first housing 110. The second housing 140 comprises a sub-opening part 142 for exposing the LCD module 120 to another direction.

Supporting ribs 143 are integrally formed with the second housing 140 to press and support edges of the driving circuit board 130 during the engagement of the second housing 140 to the first housing 110. The driving circuit board 130 is supported from the upper and lower directions by the guide ribs 111 of the first housing 110 and the supporting ribs 143 of the second housing 140 to hold the driving circuit board 130 from moving by the exterior impact. As such, a certain space always may be obtained between the driving circuit board 130 and the second housing 140.

The supporting ribs 143 are integrally formed with the second housing 140 according to the present exemplary embodiment of the present invention; however, this should not be considered as limiting. Various structures are possible and, for example, the supporting ribs 143 may be separately formed to be attached to the second housing 140.

The main LCD screen 150 is attached to the opening part 112 of the first housing 110, and the sub-LCD screen 160 is attached to the sub-opening part 142 of the second housing 140 by the second sealing member 141.

The first and second sealing members 121 and 141 may comprise a sponge or a rubber material, however, this should not be considered as limiting. Various materials are possible, as long as they can prevent dusts or contaminants from entering an LCD screen.

The assembly of a display device of a mobile phone having the aforementioned structure according to the present invention allows the driving circuit board 130 to be supported both by the top of the guide ribs 111, which take on the configuration of a square frame, of the first housing 110, and by the supporting ribs 143 of the second housing 140.

When an exterior impact is imposed on the display device in a direction of a thick arrow of FIG. 2, the impact is dispersed from the driving circuit board 130 to the guide ribs 111 of the first housing 110 such that the impact transferred to the LCD module 120 can be greatly reduced as compared to a conventional art. Additionally, the driving circuit board 130 is not moved when the impact is imposed thereon, and therefore, a constant space can be ensured between the driving circuit board 130 and the second housing 140. As a result, the LCD module is prevented from being extremely bent or damaged by the exterior impact.

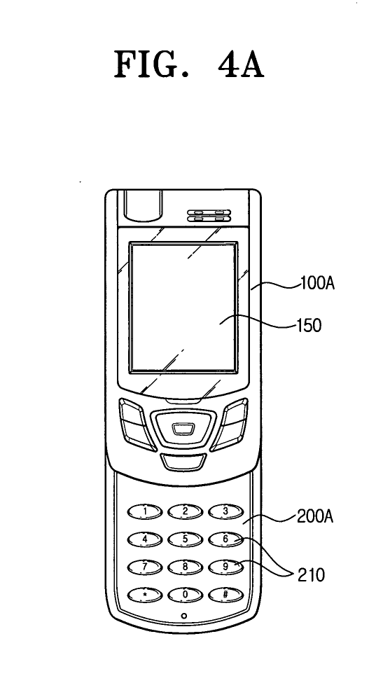

FIG. 4 is a view of a mobile phone applying a display device 100 according to an exemplary embodiment of the present invention. As shown, the display device 100 is hinged to the mobile phone body 200.

The mobile phone body 200 comprises various electric parts therein, and also has a number of keypad keys 210 for turning on/off a telecommunication, or setting functions and dialing by a user's operation. The display device 100 is hinged to the mobile phone body 200 such that the keypad keys 210 can be selectively exposed as a user opens or close the mobile phone. The display device 100 identifies a dialed telephone number or a present status of set functions for the user to see.

The detailed description of the display device 100 will be omitted for the conciseness as it has already been described above according to the present invention.

In the present embodiment, a folder type mobile phone is described in which the display device 100 is pivotably engaged with the mobile phone body 200; however, the display device 100 according to the present invention may be applied to a sliding mobile phone (see FIG. 4A where a display device 100A is slidably engaged with mobile phone body 200A) or a flip mobile phone as well as a folder type mobile phone and provide the same purposes and effects.

As described above, a display device with an improved resistance against an impact can be provided according to the present invention, and therefore, a durability and a reliability is upgraded.

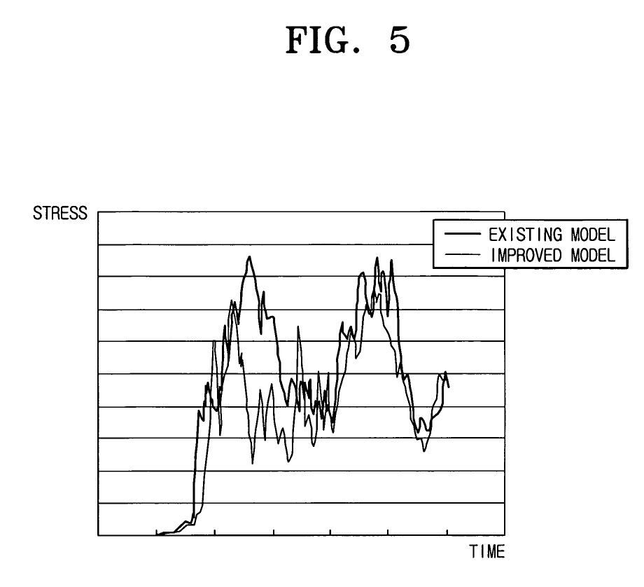

The same impact is imposed on display devices according to a conventional art and present invention, respectively, and a stress intensity to a LCD module is simulated, and the result is shown in FIG. 5. Referring to FIG. 5, the stress intensity acts appropriately 10% less when the present invention is applied.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A display device for a mobile phone comprising:
a liquid crystal display (LCD) module;
a first housing which receives and supports the LCD module, and has at least a pair of guide ribs;
a driving circuit board assembled to the first housing to be mounted and supported on the guide ribs; and
a second housing engaged with the first housing to enclose the driving circuit board and the LCD module.

2. The display device according to claim 1, comprising a further pair of guide ribs such that said pairs of guide ribs take on a configuration of a square frame.

3. The display device according to claim 1, comprising a pair of supporting ribs disposed between opposite sides of the second housing and the driving circuit board, respectively, for pressing and supporting the opposite sides of the driving circuit board during the engagement of the second housing with the first housing.

4. The display device according to claim 3, wherein the supporting ribs are integrally formed with the second housing.

5. A display device for a mobile phone comprising:
a liquid crystal display (LCD) module;
a first housing having at least a pair of guide ribs which receive and support the LCD module, and an opening part for exposing the LCD module;
a driving circuit board assembled to the first housing and mounted on a top of the guide ribs;
a second housing engaged with the first housing to enclose the driving circuit board and the LCD module, and including a sub-opening part for exposing the LCD module in another direction;
a main LCD screen attached to the opening part of the first housing; and
a sub LCD screen attached to the sub-opening part of the second housing.

6. The display device according to claim 5, comprising a further pair of guide ribs such that said pairs of guide ribs take on a configuration of a square frame.

7. The display device according to claim 6, comprising a pair of supporting ribs disposed between opposite sides of the second housing and the driving circuit board, respectively, for pressing and supporting the opposite sides of the driving circuit board during the engagement of the second housing with the first housing.

8. The display device according to claim 7, wherein the supporting ribs are integrally formed with the second housing.

9. The display device according to claim 8, wherein a first sealing member is provided between edges of the LCD module and a bottom surface of the first housing, and a second sealing member is provided between edges of the sub-LCD screen and the second housing.

10. The display device according to claim 9, wherein the LCD module engaged with the first housing by the first sealing member is the same in height as the guide ribs.

11. A mobile phone comprising:
a mobile phone body having various electric parts therein, and a number of keypads capable of turning on/off a telecommunication or setting functions and dialing by a user's operation; and
a display device selectively exposing the keypads by a user's opening and closing, and showing a dialed telephone number or a present status of a set function, the display device comprising,
a liquid crystal display (LCD) module,
a first housing having guide ribs which take on a configuration of a square frame, the first housing receiving and supporting the LCD module and having an opening part for exposing the LCD module,
a driving circuit board assembled to the first housing and mounted on a top of the guide rib,
a second housing engaged with the first housing to enclose the driving circuit board and the LCD module, and having a sub-opening part for exposing the LCD module in another direction,
a main LCD screen attached to the opening part of the first housing, and
a sub-LCD screen attached to the sub-opening part of the second housing.

12. The mobile phone according to claim 11, comprising a pair of supporting ribs disposed between opposite sides of the second housing and the driving circuit board, respectively, for pressing and supporting the opposite sides of the driving circuit board during the engagement of the second housing with the first housing.

13. The mobile phone according to claim 12, wherein the supporting ribs are integrally formed with the second housing.

14. The mobile phone according to claim 13, wherein a first sealing member is provided between edges of the LCD module and a bottom surface of the first housing, and a second sealing member is provided between edges of the sub-LCD screen and the second housing.

15. The mobile phone according to claim 14, wherein the LCD module engaged with the first housing by the first sealing member is the same in height as the guide ribs.

16. The mobile phone according to claim 11, wherein the display device is pivotably engaged with the mobile phone body.

17. The mobile phone according to claim 11, wherein the display device is slidably engaged with the mobile phone body.
